(19) United States
(12) Patent Application Publication
(10) Pub. No.: US 2007/0177004 A1
(43) Pub. Date: Aug. 2, 2007

(54) Image creating method and imaging device

(76) Inventors: Timo Kolehmainen, Oulu (FI); Markku Rytivaara, Oulu (FI); Timo Tokkonen, Oulu (FI); Jakke Makela, Turku (FI); Kai Ojala, Oulu (FI)

Correspondence Address: Hollingsworth & Funk, 8009 34th Avenue South, Suite 125, Minneapolis, MN, 55425, US

(21) Appl. No.: 10/582,064

(22) PCT Filed:
(86) PCT No.: PCT/IB03/00944

(51) Int. Cl. H04N 13/00

(52) U.S. Cl. 348/42

(57) ABSTRACT

The invention relates to a method of creating an image file in an imaging device and an imaging device comprising at least two image capturing apparatus, each apparatus being arranged to produce an image. The apparatus is configured to utilize at least a portion of the images produced with different image capturing apparatus with each other to produce an image with an enhanced image quality.

### FIELD

The invention relates to an imaging device and a method of creating an image file. Especially the invention relates to digital imaging devices comprising more than one image capturing apparatus.

### BACKGROUND

The popularity of photography is continuously increasing. This applies especially to digital photography as the supply of inexpensive digital cameras has improved. Also the integrated cameras in mobile phones have contributed to the increase in the popularity of photography.

The quality of images is naturally important for every photographer. In many situations it is difficult to evaluate correct parameters used in photographing. For example correct exposure in situations where there are well lit and dark areas nearby may be difficult. The automatic exposure programs in modern camera usually produce good quality images in many situations, but in some difficult exposure situations the automatic exposure may not be able to produce the best possible result.

Also the optical quality of cameras set limits to the image quality. Especially in low cost cameras, which are used in mobile phones, for example, the optical quality of the lenses is not comparable to high-end cameras.

### BRIEF DESCRIPTION OF INVENTION

An object of the invention is to provide an improved solution for creating images. Another object of the invention is to enhance the dynamic range of images.

According to an aspect of the invention, there is provided an imaging device comprising at least two image capturing apparatus, each apparatus being arranged to produce an image. The apparatus is configured to utilize at least a portion of the images produced with different image capturing apparatus with each other to produce an image with an enhanced image quality.

According to another aspect of the invention, there is provided a method of creating an image file in an imaging device, comprising producing images with at least two image capturing apparatus, and utilising at least a portion of the images produced with different image capturing apparatus with each other to produce an image with enhanced image quality.

The method and system of the invention provide several advantages. In general, at least one image capturing apparatus has different light capturing properties compared to the other apparatus. Thus the image produced by the apparatus is used for enhancing the dynamic range of the image produced with the other of the image capturing apparatus.

In an embodiment of the invention, at least one image capturing apparatus has a small aperture. Thus, the image produced by the apparatus has fewer aberrations, as a smaller aperture produces a sharper image. The information in the image may be utilised and combined with the images produced by other apparatus.

In an embodiment of the invention, at least one image capturing apparatus has a higher aperture than other apparatus. Thus, the apparatus gathers more light and it is able to get more details from dark areas of the photographed area.

In an embodiment of the invention, the imaging device comprises a lenslet array with at least four lenses and a sensor array. The four image capturing apparatus each use one lens from the lenslet array, and a portion of the sensor array. Three image capturing apparatus each comprise unique colour filter from a group of RGB or CMY filters or other system of colour filters and thus the three apparatus are required for producing a colour image. The fourth image capturing apparatus may be manufactured with different light capturing properties compared to other apparatus and used for enhancing the image quality produced with the three apparatus.

### LIST OF DRAWINGS

In the following, the invention will be described in greater detail with reference to the preferred embodiments and the accompanying drawings in which

FIG. 1 illustrates an example of an imaging device of an embodiment;

FIG. 2A and 2B illustrate an example of an image sensing arrangement,

FIG. 2C illustrates an example of colour image combining,

FIGS. 3A and 3B illustrate embodiments of the invention;

FIG. 4 illustrates a method of an embodiment with a flowchart, and

FIG. 5 illustrates an embodiment where a polarization filter is used.

### DESCRIPTION OF EMBODIMENTS

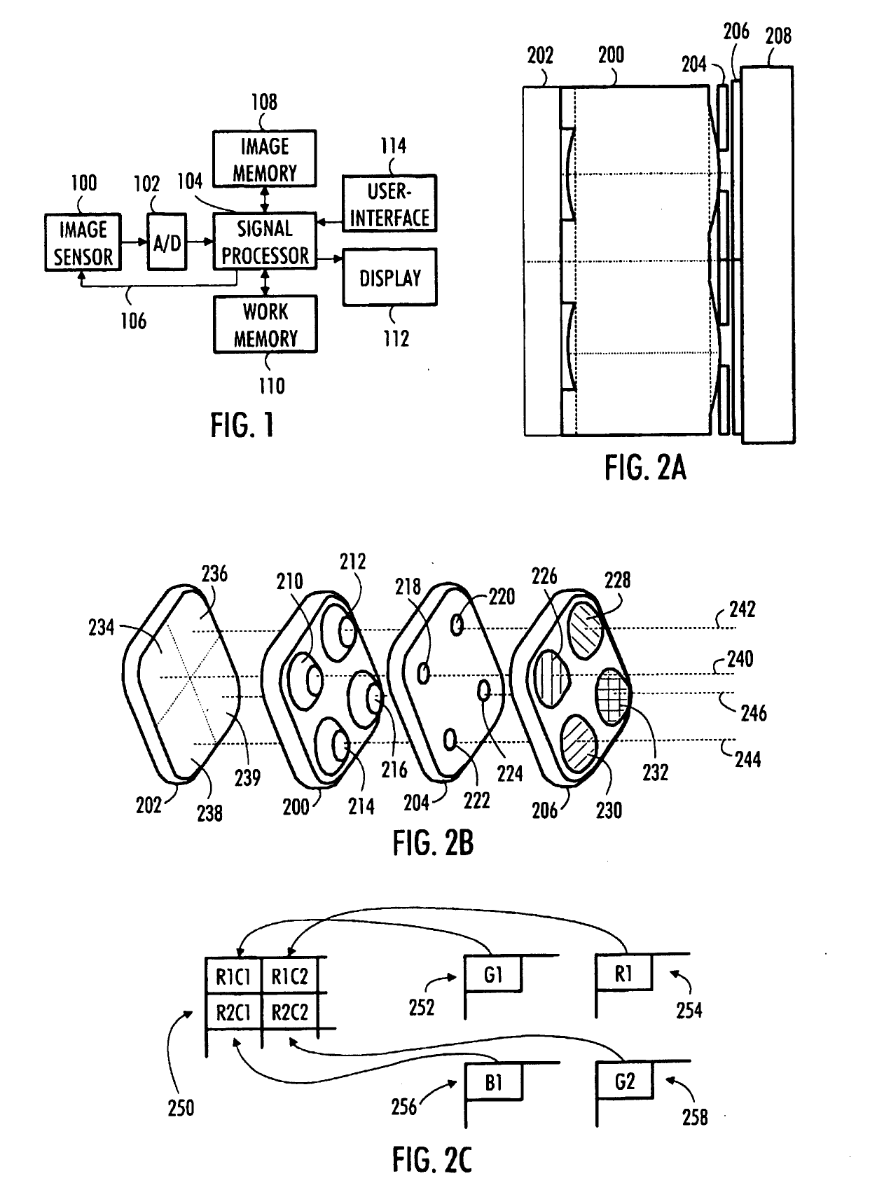

FIG. 1 illustrates a generalised digital image device which may be utilized in some embodiments of the invention. It should be noted that embodiments of the invention may also be utilised in other kinds of digital cameras than the apparatus of FIG. 1, which is just an example of a possible structure.

The apparatus of FIG. 1 comprises an image sensing arrangement 100. The image sensing arrangement comprises a lens assembly and an image sensor. The structure of the arrangement 100 will be discussed in more detail later. The image sensing arrangement captures an image and converts the captured image into an electrical form. The electric signal produced by the apparatus 100 is led to an A/D converter 102 which converts the analogue signal into a digital form. From the converter the digitised signal is taken to a signal processor 104. The image data is processed in the signal processor to create an image file. The output signal of the image sensing arrangement 100 contains raw image data which needs post processing, such as white balancing and colour processing. The signal processor is also responsible for giving exposure control commands 106 to image sensing arrangement 100.

The apparatus may further comprise an image memory 108 where the signal processor may store finished images, a work memory 110 for data and program storage, a display 112 and a user interface 114, which typically comprises a keyboard or corresponding means for the user to give input to the apparatus.

FIG. 2A illustrates an example of image sensing arrangement 100. The image sensing arrangement comprises in this example a lens assembly 200 which comprises a lenslet array with four lenses. The arrangement further comprises an image sensor 202, an aperture plate 204, a colour filter arrangement 206 and an infrared filter 208.

FIG. 2B illustrates the structure of the image sensing arrangement from another point of view. In this example the lens assembly 200 comprises four separate lenses 210-216 in a lenslet array. Correspondingly, the aperture plate 204 comprises a fixed aperture 218-224 for each lens. The aperture plate controls the amount of light that is passed to the lens. It should be noted that the structure of the aperture plate is not relevant to the embodiments, i.e. the aperture value of each lens needs not be the same. The number of lenses is not limited to four, either.

The colour filter arrangement 206 of the image sensing arrangement comprises in this example three colour filters, i.e. red 226, green 228 and blue 230 in front of lenses 201-214, respectively. The sensor array 202 is in this example divided into four sections 234 to 239. Thus, the image sensing arrangement comprises in this example four image capturing apparatus 240-246. Thus, the image capturing apparatus 240 comprises the colour filter 226, the aperture 218, the lens 210 and the section 234 of the sensor array. Respectively, the image capturing apparatus 242 comprises the colour filter 228, the aperture 220, the lens 212 and the section 236 of the sensor array and the image capturing apparatus 244 comprises the colour filter 230, the aperture 222, the lens 214 and the section 238 of the sensor array. The fourth image capturing apparatus 246 comprises the aperture 224, the lens 216 and a section 239 of the sensor array. Thus, the fourth apparatus 246 does not in this example comprise a colour filter.

The image sensing arrangement of FIGS. 2A and 2B is thus able to form four separate images on the image sensor 202. The image sensor 202 is typically, but not necessarily, a single solid-state sensor, such as a CCD (Charged Coupled Device) or CMOS (Complementary Metal-oxide Semiconductor) sensor known to one skilled in the art. In an embodiment, the image sensor 202 may be divided between lenses, as described above. The image sensor 202 may also comprise four different sensors, one for each lens. The image sensor 202 converts light into an electric current. This electric analogue signal is converted in the image capturing apparatus into a digital form by the A/D converter 102, as illustrated in FIG. 1. The sensor 202 comprises a given number of pixels. The number of pixels in the sensor determines the resolution of the sensor. Each pixel produces an electric signal in response to light. The number of pixels in the sensor of an imaging apparatus is a design parameter. Typically in low cost imaging apparatus the number of pixels may be 640×480 along the long and short sides of the sensor. A sensor of this resolution is often called a VGA sensor. In general, the higher the number of pixels in a sensor, the more detailed image can be produced by the sensor.

The image sensor 202 is thus sensitive to light and produces an electric signal when exposed to light. However, the sensor is not able to differentiate different colours from each other. Thus, the sensor as such produces only black and white images. A number of solutions are proposed to enable a digital imaging apparatus to produce colour images. It is well known for one skilled in the art that a full colour image can be produced using only three basic colours in the image capturing phase. One generally used combination of three suitable colours is red, green and blue RGB. Another widely used combination is cyan, magenta and yellow (CMY). Also other combinations are possible. Although all colours can be synthesised using three colours, also other solutions are available, such as RGBE, where emerald is used as the fourth colour.

One solution used in single lens digital image capturing apparatus is to provide a colour filter array in front of the image sensor, the filter consisting of a three-colour pattern of RGB or CMY colours. Such a solution is often called a Bayer matrix. When using an RGB Bayer matrix filter, each pixel is typically covered by a filter of a single colour in such a way that in horizontal direction every other pixel is covered with a green filter and every other pixel is covered by a red filter on every other line and by a blue filter on every other line. A single colour filter passes through to the sensor pixel under the filter light which wavelength corresponds to the wavelength of the single colour. The signal processor interpolates the image signal received from the sensor in such a way that all pixels receive a colour value for all three colours. Thus a colour image can be produced.

In the multiple lens embodiment of FIG. 2A a different approach is used in producing a colour image. The image sensing arrangement comprises a colour filter arrangement 206 in front of the lens assembly 200. In practise the filter arrangement may be located also in a different part of the arrangement, for example between the lenses and the sensor. In an embodiment the colour filter arrangement 206 comprises three filters, one of each of the three RGB colours, each filter being in front of a lens. Alternatively also CMY colours or other colour spaces. may be used as well. In the example of FIG. 2B the lens 210 is associated with a red filter, the lens 212 with a green filter and the lens 214 with a blue filter. Thus one lens 216 has no colour filter. As illustrated in FIG. 2A, the lens assembly may in an embodiment comprise an infra-red filter 208 associated with the lenses. The infra-red filter does not necessarily cover all lenses at it may also be situated elsewhere, for example between the lenses and the sensor.

Each lens of the lens assembly 200 thus produces a separate image to the sensor 202. The sensor is divided between the lenses in such a way that the images produced by the lenses do not overlap. The area of the sensor divided to the lenses may be equal, or the areas may be of different sizes, depending on the embodiment. Let in this example assume that the sensor 202 is a VGA imaging sensor and that the sections 234-239 allocated for each lens are of Quarter VGA (QVGA) resolution (320×240).

As described above, the electric signal produced by the sensor 202 is digitised and taken to the signal processor 104. The signal processor processes the signals from the sensor in such a way that three separate subimages from the signals of lenses 210-214 are produced, one filtered with a single colour. The signal processor further processes the subimages and combines a VGA resolution image from the subimages. FIG. 2C illustrates one possible embodiment to combine the final image from the subimages. This example assumes that each lens of the lenslet comprises a colour filter, in such a way that there are two green filters, one blue and one red. FIG. 2C shows the top left corner of the combined image 250, and four subimages, a green one 252, a red one 254, a blue one 256 and a green one 258. Each of the subimages thus comprises a 320×240 pixel array. The top left pixels of the subimages correspond to each other and differ only in that the colour filter used in producing the pixel information is different. The subimages are first registered. Registering means that any two image points are identified as corresponding to the same physical point. The top left pixel R1C1 of the combined image is taken from the green1 image 252, The pixel R1C2 is taken from the red image 254, the pixel R2C1 is taken from the blue image 256 and the pixel R2C2 is taken from the green2 image 258. This process is repeated for all pixels in the combined image 250. After this the combined image pixels are fused together so that each pixel has all three RGB colours. The final image corresponds in total resolution with the image produced with a single lens system with a VGA sensor array and a corresponding Bayer colour matrix.

In an embodiment, when composing the final image, the signal processor 104 may take into account the parallax error arising from the distances of the lenses 210-214 from each other.

The electric signal produced by the sensor 202 is digitised and taken to the signal processor 104. The signal processor processes the signals from the sensor in such a way that three separate subimages from the signals of lenses 210-214 are produced, one being filtered with a single colour. The signal processor further processes the subimages and combines a VGA resolution image from the subimages. Each of the subimages thus comprise a 320×240 pixel array. The top left pixels of the subimages correspond to each other and differ only in that the colour filter used in producing the pixel information is different. Due to the parallax error the same pixels of the subimages do not necessarily correspond to each other. The parallax error is compensated by an algorithm. The final image formation may be described as comprising many steps: first the three subimages are registered (also called matching). Registering means that any two image points are identified as corresponding to the same physical point). Then, the subimages are interpolated and the interpolated subimages are fused to an RGB-color image. Interpolation and fusion may also be in another order. The final image corresponds in total resolution with the image produced with a single lens system with a VGA sensor array and a corresponding Bayer colour matrix.

In an embodiment the subimages produced by the three image capturing apparatus 240-244 are used to produce a colour image. The fourth image capturing apparatus 246 may have different properties compared with the other apparatus. The aperture plate 204 may comprise an aperture 224 of a different size for the fourth image capturing apparatus 246 compared to the three other image capturing apparatus. The signal processor 104 is configured to combine at least a portion of the subimage produced with the fourth image capturing apparatus with the subimages produced with the three image capturing apparatus 240-244 to produce a colour image with an enhanced image quality. The signal processor 104 is configured to analyse the images produced with the image capturing apparatus and to determine which portions of the images to combine.

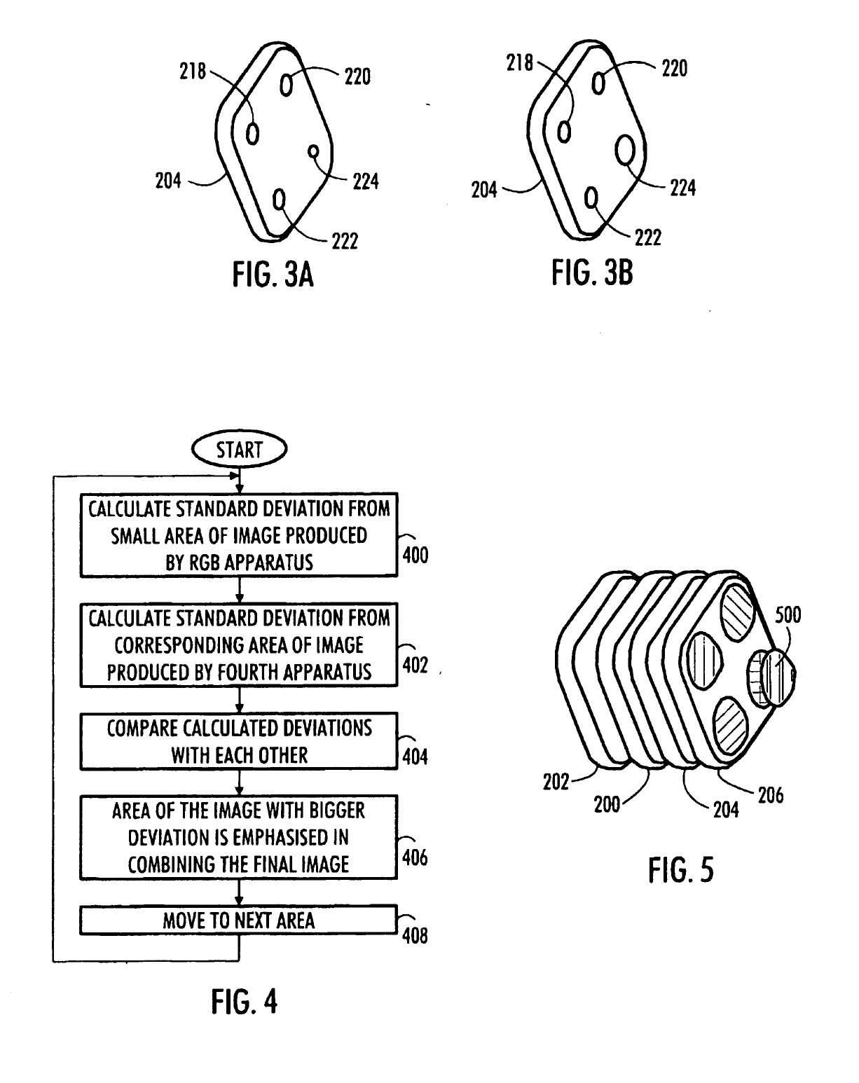

In an embodiment the fourth image capturing apparatus has a small aperture 224 compared to the apertures 218-222 of the rest of the image capturing apparatus. This is illustrated in FIG. 3A. When the aperture is small there are less aberrations in the resulting image, because a small aperture draws a sharp image. In addition, a subimage taken with a small aperture adds information on the final image on bright areas which would otherwise be over-exposed. Apertures are usually denoted with so called F-numbers. They denote the size of the aperture hole, through which the light passes to the lens. F-numbers are a fraction of the focal length of a lens. Thus, the smaller the F-number the more light is passed to the lens. For example, if the focal length of a lens is 50 mm, an F-number of 2.8 means that the aperture is 1/2.8of 50 mm, i.e. 18 mm. A small aperture in this embodiment corresponds to F-number 4 or greater.

In an embodiment the fourth image capturing apparatus has a larger aperture 224 than the apertures 218-222 of the rest of the apparatus. This is illustrated in FIG. 3B. The large aperture enables the apparatus to have better light sensitivity compared to other apparatus. The difference between the apertures is preferably fairly great. With this solution a large dynamic range is achieved. The final image has a lower noise level because it is averaged using many images. The dynamic area is bigger. The final image will have more details in otherwise dark areas of the image. In this way, the final Image contains more details in areas where the light intensity is low. These areas would be dark without the dynamic range enhancement.

The subimage produced by the fourth image capturing apparatus 246 may be a black and white image. In such a case the colour filter arrangement 206 does not have a colour filter for the fourth lens 216. In an embodiment the colour filter arrangement 206 may comprise a separate Bayer matrix 232 or a corresponding colour matrix filter structure. Thus the fourth lens can be used to enhance a colour image.

The subimage or portions of the subimage produced with the fourth image capturing apparatus and the subimages produced with the three image capturing apparatus 240-244 may be combined by the signal processor 104 using several different methods. In an embodiment the combining is made using an averaging method for each pixel to be combined:

$${PV}_{final\_R} = \frac{{PV}_{R} + {PV}_{4}}{2} , \\ {PV}_{final\_G} = \frac{{PV}_{G} + {PV}_{4}}{2}$$

$${PV}_{final\_B} = \frac{{PV}_{B} + {PV}_{4}}{2}$$

where PV_{final—R}, PV_{final—G} and PV_{final—B} are final pixel values, PV_{R}, PV_{G}, and PV_{B} are the pixel values of red, green and blue filtered apparatus (in the example of FIG. 2B, the pixel values from the subimages produced by the apparatus 240, 242 and 244), and PV₄ is the pixel value of the fourth apparatus 246.

In an embodiment the combining is made using a weighted mean method for each pixel to be combined:

$${PV}_{final\_R} = \frac{M * {PV}_{R} + ( 255 - M ) * {PV}_{4}}{255} , \\ {PV}_{final\_G} = \frac{M * {PV}_{G} + ( 255 - M ) * {PV}_{4}}{255} , \\ {PV}_{final\_B} = \frac{M * {PV}_{B} + ( 255 - M ) * {PV}_{4}}{255} ,$$

where M=(PV_{R},+PV_{G}+PV_{B})/3 and PV_{final—R}, PV_{final—G} and PV_{final—B} are final pixel values. PV_{R}, PV_{G}, and PV_{B} are the pixel values of red, green and blue filtered apparatus.

Since the fourth apparatus produces black and white images, also the colour saturation must be increased for the combined pixels.

In the above example the algorithm is for the situation where the aperture of the fourth apparatus 246 is larger than in other apparatus. In the weighted mean method information of the final image is taken mainly using the three RGB apparatus. Information produced by the fourth apparatus with the larger aperture can be utilised for example in the darkest areas of the image. The above algorithm automatically takes the above condition into account.

In the embodiment where the aperture of the fourth apparatus is smaller and the image thus sharper than in the other apparatus the images may be combined with an averaging or advanced method, where the images are compared and the sharpest areas of both images are combined into the final image. The amount of information in each image can be measured by taking standard deviation from the small areas of the images. The amount of information corresponds to sharpness. The flowchart of FIG. 4 illustrates the method. In phase 400, standard deviation from a small area of the image produced with the three RGB apparatus is calculated. In phase 402, standard deviation from a corresponding area of the image produced with the fourth apparatus is calculated. In phase 404 these deviations are compared with each other. In phase 406, the area which has bigger deviation is assumed to be sharper and it is emphasised when producing the final image. In phase 408 the attention is moved to the next area.

With the above method a well balanced contrast is achieved for the whole image area. This applies especially to situations where there are high contrast differences in the image. In addition, the amount of information on the image can be increased and perceived noise decreased.

In an embodiment, the fourth apparatus is configured to use different exposure time compared to other apparatus. This enables the apparatus to have different light sensitivity compared to other apparatus.

In an embodiment, the fourth apparatus produces infra-red images. This is achieved by removing the infra-red filter 208 at least partially in front of the lens 216. Thus near-IR light reaches the sensor. In this case the colour filter arrangement 206 does not have a colour filter for the fourth lens 216. The infra-red filter may be a partially leaky Infra-red filter, in which case it passes both visible light and infra-red light to the sensor via the lens 216. In this embodiment the fourth apparatus may act as an apparatus to be used for imaging in darkness. Imaging is possible when the scene is lit by an IR-light source. The fourth apparatus may also be used as a black/white (B/W) reference image, which is taken without the infra-red filter. The B/W image can also be used for document imaging. The lack of a colour filter array enhances the spatial resolution of the image compared to a colour image. The reference B/W image may also be useful when the three colour filtered images are registered. The registration process is enhanced when a common reference image is available.

FIG. 5 illustrates an embodiment of the invention. FIG. 5 shows the lens assembly 200, the image sensor 202, the aperture plate 204 and the colour filter arrangement 206 in a more compact form. In this embodiment the fourth apparatus comprises a polarization filter 500. A polarization filter blocks light waves which are polarized in perpendicular to the polarization direction of the filter. Thus, a vertically polarized filter does not allow any horizontally polarized waves to pass through. In photography (and also in sunglasses) the most common use of polarized filters is to block reflected light. In sunshine horizontal surfaces, such as roads and water, reflect horizontally polarized light. In an embodiment of the invention the fourth apparatus comprises a vertically polarized filter which allows non-polarized light to pass through but blocks reflected light. In an embodiment of the invention the fourth apparatus comprises a polarization filter which can be rotated by the user.

The polarization filter may also be used with the other embodiments described above. However, in the following discussion it is assumed that the lens with the polarization filter is similar in optical and light gathering properties compared to the other subsystem in order to simplify calculations.

In an embodiment, the default image produced by the non-polarized apparatus is defined to be the “normal image” NI. This is the image that is transmitted to the viewfinder for the user to view and stored in memory as the main image. The polarized image PI is stored separately.

In an embodiment, the user is able to decide whether or not to use the information contained in PI to manipulate NI to form a “corrected image” CI. For example, when viewing images, he can be presented with a simple menu, which allows him to choose the “glare correction”, if desired.

In an embodiment, the correction is made automatically and the corrected image is shown on the viewfinder and stored. Thus, the user does not need to be aware that any correction has even been made. This is simple for the user, but taking the image requires more processing and is more difficult to realize in real time. Also, it is usually preferable to store PI together with CI, in case the processing to create CI cannot be done correctly. This may happen e.g. if one of the lenses is dirty or the sensors lose their calibration over time, which results in the optical systems of the lenses being non-identical.

To make corrections, the image taken by the other apparatus and the polarized image taken by the fourth apparatus are reformatted into a same colour space in which there is only the intensity component (i.e. the are reformatted into greyscale images, for example). In an implementation, this could be the Y component of a YUV-coded image. These reformatted images may be called NY (for the normal image) and PY (for the polarized image). Mathematically, NY and PY are matrices containing the intensity information about NI and PI.

If there is no preferred orientation of the polarization, NY and PY are linearly proportional:
PY=k*NY,
with k<1 because the polarizing filter blocks out some of the light. However, if the light coming to part of the image is strongly polarized in a specific direction, the NY image will be overexposed compared to the PY image in these locations if the polarizing filter is oriented so that it blocks light in this specific direction of polarization. As described above, such a situation most typically occurs when light is reflected from a large flat surface, e.g. water or a road surface, and is then primarily horizontally polarized. This excess of reflected light (the glare) is what causes the partial overexposure of the image NY.

Mathematically, the simple linear relationship between PY and NY is lost in the presence of glare, and the relationship must be defined with a matrix X having the same dimensions as PY and NY. The relation is the pointwise product
PY=X·NY.

It should be noted that this is a pointwise product and not a matrix product. Most of the pixel values Xᵢⱼ in the matrix X are equal to k, but where the polarizing filter has blocked a significant amount of light from a given location, the pixel values Xᵢⱼ are much smaller. The matrix X is thus essentially a “map” of the areas with reflected light: where there is significant reflection, the map is dark (close to zero), while it has a constant non-zero value in other areas. However, since the above equation is a non-linear equation, simplifications must be made to utilize this equation practically. In an embodiment, the “glare matrix” GM is defined to be a greyscale image with the same dimensions as PY and NY. GM is not uniquely defined, but is related to X in that it is a measure of the “excess light” which is to be removed from the image. In this embodiment, GM may be defined empirically from the formula
GM=(c₁*NY−c₂*PY)/(c₁+c₂).

The values of C₁ and C₂ may be determined empirically or they may be defined by the user. From this, the corrected greyscale image CY is then given by
CY=(C₃^{*}NY−C₄^{*}GM) / (C₃+C₄),
where the values of C₃ and C₄ may again be empirically determined or user-defined constants. From this, it is possible to determine the final corrected image by transforming CY back into the original colour space (in the simplest embodiment by simply using the U and V fields for the original NI and transforming
(CY, U, V)−>CI.
The specific embodiment shown is only one of many, but illustrates the main steps needed: transformation into at least one common colour space, evaluation of the glare effect in each of these colour spaces, elimination of the glare effect in each of these colour spaces, and transformation back into the original colour space. Note that these steps could also be done separately for each colour in an RGB space rather than transforming to a YUV space as shown in the above embodiment.

In an embodiment, at least one image capturing apparatus is shielded for producing a dark reference. The image sensor converts light into en electric current. The image sensor is a temperature sensitive unit and generates a small electric current, which depends on the temperature of the sensor. This current is called a dark current, because it occurs also when the sensor is not exposed to light. In this embodiment one apparatus is shielded from light and thus produces an image based on the dark current only. Information from this image may be used to suppress at least part of the dark current present in the other apparatus used for producing the actual image. For example, the dark current image may be subtracted from the images of other apparatus.

In an embodiment, at least one image capturing apparatus is used for measuring white balance or measuring exposure parameters. Usually digital cameras measure white balance and exposure parameters using one or more captured images and calculating parameters for white balance and exposure adjustments by averaging pixel values over the image or over the images. The calculation requires computing resources and increases current consumption in a digital camera. In such a case the same lens that creates the image is also used for these measuring purposes. In this embodiment the imaging apparatus has a dedicated image capturing apparatus with a lens arrangement and image sensor area for these measuring purposes. The required software and required algorithms may be designed better as the image capturing and the measuring functions are separated to different apparatus. Thus measuring can be made faster and more accurately than in conventional solutions.

When performing white balance or exposure parameters measurement the associated image capturing apparatus detects spectral information by capturing light intensity in many spectrum bands by means of diode detectors with corresponding colour filters (for example, red, green, blue and near-IR bands are used). These parameters are used by the processor of the imaging device for estimating parameters needed for white balance and exposure adjustment. The benefit is a processing time much reduced compared to the case of calculating these parameters by averaging over a full image.

The white balance and exposure parameters may also be calculated by taking a normal colour image with the image capturing apparatus and averaging pixels over the image in a fashion suitable for white balance and exposure adjustment. In an embodiment the image may be saved and used for later image post-processing on computer, for example.

In an embodiment, each image capturing apparatus has a different aperture size. Each image capturing apparatus produces a colour image. Each image capturing apparatus comprises a colour filter. Large aperture variations enable high dynamic range imaging.

Images of two or more image capturing apparatus may be used to compose a dynamically enhanced colour image. The images may be registered and averaged pixelwise to achieve a high dynamic range colour image.

Weighted averaging may also be used as an advanced method to combine images. The weight coefficient can be taken from the best exposure image or derived from all sub-images. The weight value indicates what subimages to use as the source of information, when calculating pixel value in final image. When the weight value is high the information is taken from small aperture cameras and vice versa.

Typically the camera sensor sensitivity is dependent on wavelength. For example, the sensitivity of a blue channel is much lower than that of a red channel in both CCD and CMOS sensors. A bigger aperture increases light flux, thus allowing more photons to the sensor. The lower the sensor sensitivity to a certain channel, the bigger the corresponding aperture size should be. The aperture variations of the image capturing apparatus enable a good signal balance between colour channels with similar signal-to-noise ratios. In an embodiment each image capturing apparatus comprises a different aperture size and each image capturing apparatus is dedicated to its own spectral band (for instance: R, G, B, Clear).

Even though the invention is described above with reference to an example according to the accompanying drawings, it is clear that the invention is not restricted thereto but it can be modified in several ways within the scope of the appended claims.

1. An imaging device comprising at least two image capturing apparatus, each apparatus being arranged to produce an image comprising pixels, the apparatus being configured to utilize at least a portion of the images produced with different image capturing apparatus with each other to produce an image with an enhanced image quality, wherein at least one image capturing apparatus has a different light gathering capability and the image produced by the at least one apparatus is used for enhancing the dynamic range of the image produced with the other image capturing apparatus by combining at least a portion of the images using an averaging method for each pixel to be combined.

2. The device of claim 1, comprising an image capturing apparatus configured to analyse the images produced with the image capturing apparatus and to determine which portions of an image to utilize.

3. The device of claim 1, comprising an image capturing apparatus configured to combine at least a portion of the images produced with different image capturing apparatus with each other.

4. The device of claim 1, wherein at least one image capturing apparatus has a small aperture.

5. The device of claim 1, wherein at least one image capturing apparatus has higher aperture than other apparatus.

6. The device of claim 1, comprising an image capturing apparatus configured to utilise a weighted mean method for each pixel to be combined.

7. The device of claim 1, wherein at least one image capturing apparatus comprises a polarisation filter.

8. The device of claim 1, wherein the image capturing apparatus comprise a lens system and a sensor array configured to produce electric signal and the device comprises a processor operationally connected to the sensor arrays and configured to produce an image proportional to the electrical signal received from the sensor arrays.

9. The device of claim 8, comprising a sensor array divided between at least two image capturing apparatus.

10. The device of claim 1, comprising a lenslet array with at least four lenses.

11. The device of claim 8, comprising a sensor array and four image capturing apparatus, each apparatus using one lens from the lenslet array and a portion of the sensor array.

12. The device of claim 9, wherein three image capturing apparatus are configured to produce a colour image; that the fourth image capturing apparatus is configured to produce an image; and the device comprises a processor configured to combine at least a portion of the images with each other to produce an image with an enhanced image quality.

13. The device of claim 10, wherein the three image capturing apparatus each comprise an unique colour filter from a group of filters red, green or blue.

14. The device of claim 10, wherein each of the three image capturing apparatus comprises a unique colour filter from a group of filters cyan, magenta or yellow.

15. The device of claim 12, wherein the fourth image capturing apparatus comprises a Bayer matrix.

16. The device of claim 12, wherein the fourth image capturing apparatus produces infra-red images.

17. The device of claim 1, comprising at least one image capturing apparatus shielded for producing a dark reference.

18. The device of claim 1, comprising at least one image capturing apparatus is configured to measure white balance.

19. The device of claim 1, comprising at least one image capturing apparatus configured to measure exposure parameters.

20. The device of claim 1, comprising at least one image capturing apparatus comprising a polarization filter.

21. The device of claim 1, comprising at least one image capturing apparatus configured to produce images from which a specific light polarization direction has been removed.

22. The device of claim 1, wherein each image capturing apparatus comprises a different aperture and is dedicated to a different spectral band.

23. The device of claim 1, wherein each image capturing apparatus comprises a lens arrangement.

24. The device of claim 1, wherein at least one image capturing apparatus is configured to use a different exposure time compared to other apparatus.

25. A method of creating an image file in an imaging device, comprising producing images comprising pixels with at least two image capturing apparatus, utilising at least a portion of the images produced with different image capturing apparatus with each other to produce an image with an enhanced image quality, producing images with image capturing apparatus of a different light gathering capability and combining at least a portion of the images using an averaging method for each pixel to be combined.

26. The method of claim 25, further comprising:
analysing the images produced with the image capturing apparatus and determining which portions of the images to utilize.

27. The method of claim 25, wherein the combining is made using a weighted mean method for each pixel to be combined.

28. The method of claim 25, further comprising:
producing images with image capturing apparatus comprising a lens system and a sensor array configured to produce an electric signal and
processing the images proportional to the electric signal with a processor operationally connected to the sensor arrays.

29. The method of claim 25, further comprising:
producing images with a sensor array and four image capturing apparatus, each apparatus using one lens from the lenslet array and a portion of the sensor array.

30. The method of claim 29, further comprising:
producing a colour image with three image capturing apparatus,
producing an image with the fourth image capturing apparatus and
combining at least a portion of the images with each other to produce an image with an enhanced image quality.

31. The method of claim 30, further comprising:
producing a colour image with the fourth capturing apparatus by using a Bayer matrix filter.

32. The method of claim 30, further comprising:
producing an infra-red image with the fourth capturing apparatus.

33. The method of claim 25, further comprising:
combining at least a portion of the images produced with different image capturing apparatus with each other.

34. The method of claim 25, further comprising:
using at least one image capturing apparatus for producing a dark reference.

35. The method of claim 25, further comprising:
using at least one image capturing apparatus for measuring white balance.

36. The method of claim 25, further comprising:
using at least one image capturing apparatus for measuring exposure parameters.

37. The method of claim 25, further comprising:
using at least one image capturing apparatus for producing images from which a specific light polarization direction has been removed.

38. The method of claim 25, further comprising:
producing images by each image capturing apparatus with a lens arrangement of its own.

39. An imaging device comprising at least two image capturing apparatus, each apparatus being arranged to produce an image, where in at least one image capturing apparatus is used for measuring exposure parameters.

40. The imaging device of claim 39, comprising at least four image capturing apparatus, wherein three image capturing apparatus each comprise an unique colour filter from a group of filters red, green or blue or from a group filters cyan, magenta or yellow.

41. An imaging device comprising at least two image capturing apparatus and a sensor array configured to produce an electric signal when exposed to light, the sensor array being divided between at least two image capturing apparatus.

42. A method of creating an image file in an imaging device, comprising producing images with at least two image capturing apparatus and using at least one image capturing apparatus for measuring exposure parameters.
